(19) United States
(12) Patent Application Publication
(10) Pub. No.: US 2005/0049528 A1
(43) Pub. Date: Mar. 3, 2005

(54) System and device for massage, pressure-treatment and heat-treatment of skin and parts of the body

(75) Inventor: Fredrik Lagercrantz, Skultuna (SE)

Correspondence Address: Mr Fredrik Lagercrantz, Karlbergsvagen 14, Skultuna, S-73050, SE

(73) Assignee: Fredrik Lagercrantz, Skultuna (SE)

(21) Appl. No.: 10/962,822

(22) Filed: Oct. 7, 2004

(30) Foreign Application Priority Data
May 6, 2002 (SE) 0201383-7
Jul. 29, 2003 (SE) PATENT 520 599
Apr. 28, 2003 (WO) PCT/SE03/00673

(51) Int. Cl. A61H 15/00; A61H 7/00

(52) U.S. Cl. 601/87; 601/113; 601/119; 601/127

(57) ABSTRACT

The device consists of an outer flexible membrane, which can be pressed against a part of a body and inner rollers or balls which can be made to roll against the membrane and thus produce a wandering movement of elevations or crowns on the membrane. In this way it is possible to get a wandering movement of the elevations on the membrane while the membrane can be kept stable pressed against the skin. The wavelike movement simplifies and improves the circulation by pushing the body liquids around in the treated area. The treatment can be combined with pressurizing and heating in order to improve healing and shaping of body parts.

### BACKGROUND OF THE INVENTION

The present invention relates to a device to be used for massaging the skin and parts of the body in order to stimulate the circulation, improve healing, reduce the formation of scares, reduce or eliminate wrinkles, form parts of the skin and body parts during healing and give an increased wellbeing.

The device can be used to expose a damaged part of the body to pressure, which can speed up different chemical and biological functions. The technique can be used to form or adjust the surface of the treated body during for instance healing and at the same time enhance the circulation and bloodstream to the area. The method there for has many applications within plastic surgery.

Since the massaging surface can be made flexible and mouldable a good contact against the treated area can be kept. On the surface of the membrane a wavelike movement can be created and at the same time the membrane is kept against the skin without displacement or sliding.

Depending on how the moving rollers or balls are combined with the height and length of the track a varying wavelike movement can be created. The massage can be made efficient and improve circulation and blood steam to all parts of the skin which are being treated.

The invention can be used to increase well being and stimulate circulation. This is done by deforming the surface of the membrane and by doing so create a wave-like movement which is moved along the membrane without displacing the membrane in any significant way in relation to the treated surface.

The invention can be used to improve the healing effect in wounds by increasing circulation and bloodstream in the area and at the same time keep the area under pressure. During healing of wounds scars are often formed because the skin has been damaged or deformed or because the wound is badly kept together.

By keeping the surface smooth and even by a membrane the damaged area can be formed in order to heal in a desired way and at the same time increase circulation and thus improve the healing.

The invention can be used to increase metabolism in certain parts of the body and reduce weight which means that the invention can be used to simplify slimming.

By inserting the treatment locally without influencing other parts of the body, local fat assemblies can be reduced and local deformations can be influenced.

The Present Status of Technology

At present different types of equipment, methods and medicines are being used to stimulate circulation and bloodstream and thus cure different diseases and defects or improve health.

This can be made by using massage, support, pressure or heating.

There are also methods for treating body parts by thermotherapy in order to counteract different types of problems such as pain, injuries and diseases. Examples of illnesses which are treated with heat and massage are fibromyalgi and reumatism. These illnesses are treated with both heat and massage and physical training. Hot baths, manual massage and training equipment of different types are being used. Cancer is also treated with heat.

It is also known that, chemical reactions can be initiated, speeded up and accelerated when pressure and heat is applied as well as when movement, deformation and mixing is being performed. Examples of this can be found in chemical industry.

It is also known that heat does influence biological reactions, which is a fundament in all cultivation.

It has also been found during recent years that biological products such as berries and fruit can be influenced and increase taste by applying pressure and heat. The reactions can be accelerated and improved through a combination of pressure, heat and movement.

It has also been discovered that healing of wounds can be improved and accelerated if the area around the wound is subject to pressure. There is however a risk that the pressure goes to high and the muscles can be damaged because of insufficient circulation and a to low oxygen level.

There is a lack of equipment for giving an efficient and good massage without having negative effects. Neither is there any equipment available which gives an efficient massage in a simple way without any negative effects. There is also a lack of equipment giving a varied massage with a continuously varied pattern of movement so that different parts of the skin are treated in a varied way.

There is no efficient technology to pressurise a part of the skin without risking that the circulation and bloodstream is reduced or stopped so that injuries occur. It is also desirable to combine massage, pressurising and heating. An efficient equipment for this is not available or it does not give a complete, varied and combined treatment

It is known that massage of different parts of the body has or may have positive effects for counteracting different types of injuries or defects. It can have a positive effect against pain.

Massage has often been used to reduce different physical problems. Massage can also have a positive influence on mental or social problems.

In order to give massage there are many different types of equipments, which have been developed based on vibrating or oscillating elements. The part which is in contact with the skin is often given a movement sideways which is stretching the skin sideways.

There are also equipments with massaging elements moving in different patterns in relation to the skin. The movements can be back and forth in different directions, rotating or oscillating.

There are also equipment developed with rollers of different types which are being drawn along the part of the body to be treated. There are also equipments with driven rollers of different types.

The present invention gives an efficient massage without stretching unnecessarily or rubbing or vibrating the skin or body. The membrane stays pressed against the skin and a wavelike movement is produced on the surface. At the same time pressure can be applied and heat can be added.

### DETAILED DESCRIPTION OF THE INVENTION

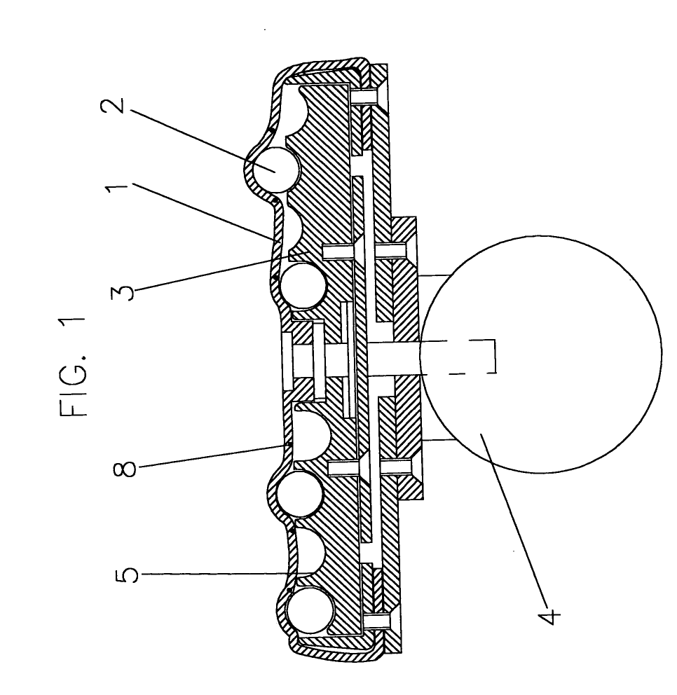

The equipment consists of an outer membrane (1) or a flexible plate and an inner movable part (3) (FIG. 1) consisting of a rotating plate (3) which can be flexible or a sideways movable plate or an endless belt (7) which can be turned around, supported by two or several shafts and rollers or balls (2) positioned between the belt and the inner movable part running between the belt (7) and the membrane (1).

The inner movable part can be driven by a motor (4) such as an electric motor. The balls (2) or the rollers deform the outer flexible membrane (1) locally and when the inner plate is moved there is a wandering elevation on the outer surface of the membrane. The elevation can move along the membrane even though the membrane is lying still against the skin.

The skin and the body part is subject to a massaging movement without stretching the skin unnecessarily. The deformation is mainly done in a plane vertical to the skin. The skin and the body member are exposed to a massaging deformation without stretching the skin. The deformation is mainly done in a plane vertical to the skin. Especially the membrane (1) is made in a flexible material in order to get a good and even contact with the skin.

The device is made so that a force in a direction perpendicular to the membrane can be applied and gives an even pressure between the membrane and the skin.

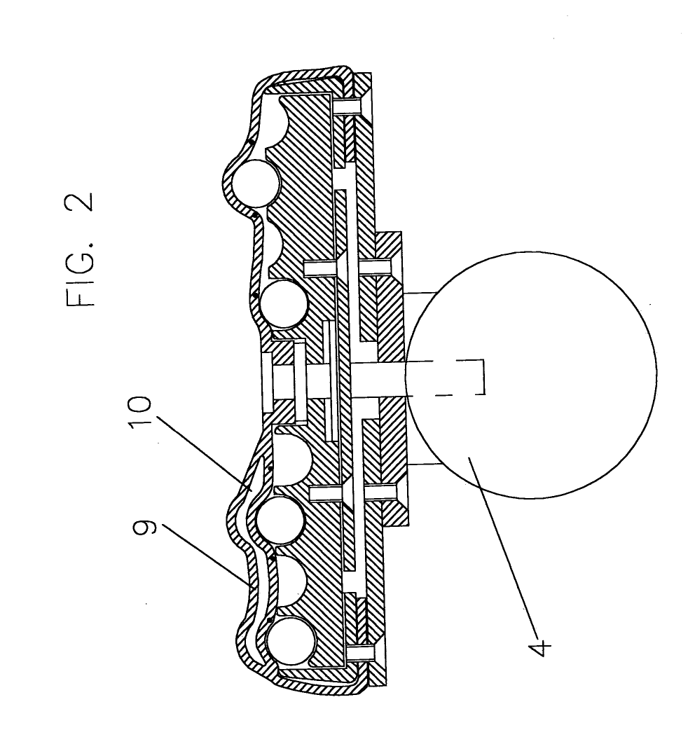

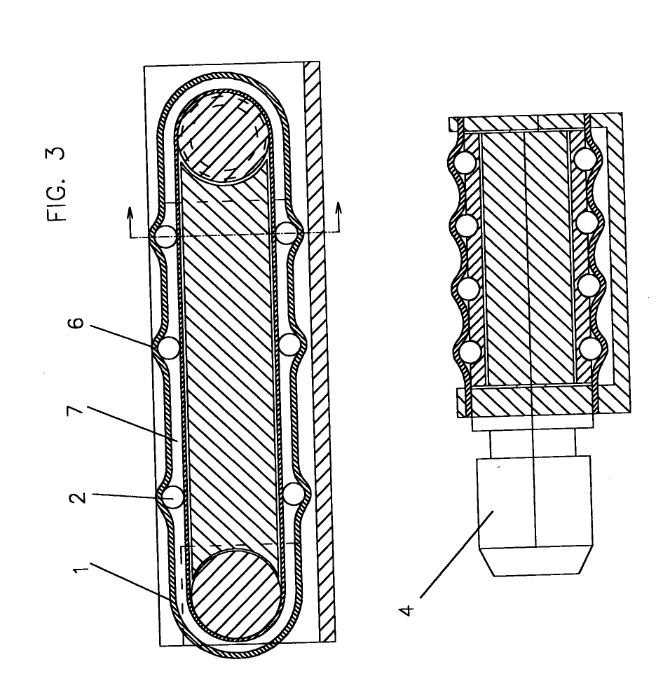

The membrane can be made with double walls (9) (FIG. 2) in order to fill it with a liquid and thereby get an even contact with the skin when the membrane is pushed against a part of the body.

The membrane can also be equipped with an inlet and an outlet in order to be able to add a heating or cooling liquid during the treatment (FIG. 2) which can also be kept under a predetermined pressure. Alternatively electrical circuits can be installed in the membrane for heating.

The device can be used to give a combination of massage, pressure treatment and heat treatment according to different programs of treatment. The circulation is kept effective during the pressure treatment since a wavelike deformation (6) of the membrane is moving along the membrane. The wave can move along the membrane without moving the membrane in relation to the skin.

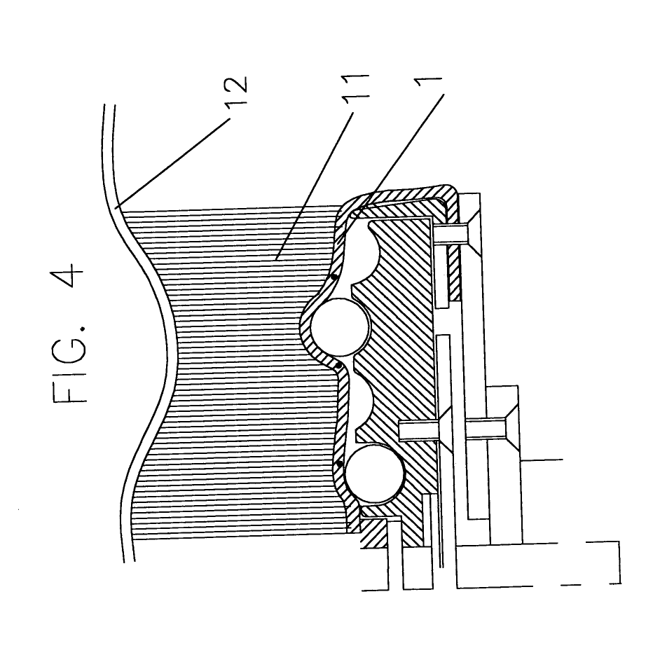

The circulation is kept moving since a wavelike movement is pushing the blood and body liquids in the direction of the wave. In spite of the pressure exposed on the skin by the membrane which can form the skin and stop or reduce the circulation there will be a certain forced pushing of the liquids through the treated area by the wave movement. By combining several balls (2) or rollers with tracks of different lengths and different depths in the membrane and/or the plate (3) an irregular and varied pattern of movement can be produced. The balls (2) or rollers wander around with different lengths of the track and the balls can be used with different diameter in order to get different elevations of the movement. The pattern of the movements can be accomplished with an almost unlimited variation of its pattern. The circulation is improved in many directions and different parts. The massage becomes more varied and improves the effect of the massage and wellbeing. A variant of the device (FIG. 4) can be used to restore skin or form the skin or body parts. This variant of the equipment consists of a device with an inner membrane (1) which is pushed out by wandering balls under the membrane (1) and produces a wandering ridge on the inner still standing membrane (1). The membrane in turn is connected to a secondary membrane (12) by a great number of standing pins (11). The pins are fixed by vulcanization or glueing or fixed in the casting process to the membrane or fixed in some other way to the membrane. A wandering ridge on the inner membrane produces a corresponding movement on the secondary membrane independently of its shape. The secondary membrane has been given a shape corresponding to the body or the desired shape of the body. The standing pins must have a specified length resulting in a desired shape and movement giving the secondary membrane a desired shape and movement. The length of the pins (11) must be adapted to its purpose in order to get the right shape of the secondary membrane.

The drawings show devices with guiding tracks. Equivalent devices can be made plates without guiding tracks.

Drawing nr 1 shows a circular plate (3) with guiding tracks (5) where the balls (2) can roll and an outer membrane (1) with incorporated heating elements (8). When the plate (3) is rotated by the motor (4) the balls (2) will move in a circular pattern under the membrane (1) and push up ridges on the membrane which will move with the movement of the balls (2).

Drawing nr 2 shows an equivalent unit with a secondary membrane (9) and a chamber in between the primary membrane and the secondary membrane. This chamber can be used to even out the pressure from the primary membrane which is transferred to the secondary membrane and on to the treated part.

Drawing nr 3 shows a massaging unit with a continuous belt (7) which is driven and running around two rollers of which one is driven by a motor (4). The belt has guiding tracks in which balls or rollers are running. Outside and surrounding the belt and balls a fixed membrane (1) is held in position by fixing brackets. When the belt (7) is moved around its supporting rollers the balls will roll in the guiding tracks and push up crowns or ridges on the outer membrane as they roll along between the belt and the membrane. The crowns or ridges will move along the membrane at approximately half the speed of the speed of the belt (8).

Drawing nr 4 shows a device according to drawing nr 1 with a secondary membrane (9) connected to the primary membrane (1) through a number of pins (11). The pins have varying length giving the secondary membrane (9) a desired shape which can be adjusted to suit a specific part which is to be treated.

The massaging unit can be made in a simplified version without the central holding of the membrane shown in FIG. 1. In this case the membrane will be kept in position against the balls or rollers by the form of the rotating plate (3) which can have a bent or convex shape like part of a sphere.

1. A device for exercising massage to parts of the body and/or skin comprising an outer flexible membrane with or without guiding tracks kept against a movable part consisting of a plate with or without tracks with equal or varying depth which serve as guiding means for balls or rollers rolling freely between the plate and the membrane and said plate which is driven by a motor and said balls or rollers elevate crowns or ridges on said membrane which wander on the outside of the membrane as the motor moves the plate in relation to the membrane and that the height of said crowns or ridges depend on the size of the balls or rollers and/or the distance between the different parts or sections of the plate and membrane and thereby giving a massaging effect as the membrane is held against a part of the body.

2. A device for exercising massage to the skin or body according to claim 1 comprising an inner circular plate which is rotated around its shaft perpendicular to the extension of the membrane and said plate having circular or elliptical tracks or tracks with varying radiuses and varying or equal depths where the balls or rollers wander when the plate is rotated in relation to the membrane and thereby elevating ridges or crowns which wander around the membrane giving a wavelike movement to the surface of the membrane and thereby giving a massage treatment to the body part pressed against the membrane.

3. A device for exercising massage according to claim 1 with a square or mainly rectangular outer active surface comprising an outer flexible membrane supported by an inner endless movable belt with endless tracks of varying depths or constant depth in which rollers or balls are wandering so that ridges or crowns are elevated and formed on the outside of the membrane and wander along the membrane as the belt is driven forward by a motor or by hand.

4. A device for exercising massage according to claim 1 comprising the outer membrane which is kept or pushed against a body part or skin with a controlled pressure and thereby compressing the skin and simultaneously upholding the circulation or creating an improved circulation in the tissue by the effect of wandering movements of the ridges or crowns and thus improving healing and/or reduce the formation of scars.

5. A device for exercising massage according to claim 1 comprising the apparatus with a special outer membrane with double walls which are to be held against the body part to treat with an almost even pressure which is ensured by controlling the pressure in the chamber inside the special membrane and thus compressing the skin and simultaneously ensuring and/or improving the circulation in the skin by the wavelike movements along the surface of the membrane which are created by the rolling balls or rollers and thus evening out deformations of the skin such as wounds and/or reducing or eliminating wrinkles.

6. A device for exercising massage according to claim 1 comprising a device with a modified membrane which has incorporated heating elements in the form of electrical elements or tubes or chambers for passing warm liquid kept at a controlled pressure and the circulation is ensured or improved by the wavelike movements created on the outside of the membrane and thus stimulating biological functions and reduce fatness.

7. A device for exercising massage according to claim 1 comprising the device with a secondary membrane or plate with a predetermined shape mounted against the primery special membrane via parallel pins and said secondary membrane is to be kept against the body part or skin to be treated with a controlled pressure and the circulation is ensured or improved by the wavelike movements created on the outside of the membrane transferred through the material from the primery membrane (1) and thus creating a formation of the skin and/or the body part.

8. A device for exercising massage according to claim 7 comprising an apparatus with a secondary membrane built up from an outer secondary membrane connected to the primery membrane by pins perpendicular to the primery membrane and that the massaging movement is transferred to the secondary membrane with a predetermined shape which is given a desired shape.

9. A device for exercising massage according to claim 7 comprising an apparatus with a primary membrane and a secondary membrane connected to the primary membrane creating a chamber in between which is filled with a liquid or other flexible material with the purpose of ensuring that an even pressure is maintained between the membrane and the skin during the treatment.

10. A device according to claim 7 comprising a device with a secondary membrane or a plate with several sections which can be kept under individually controlled pressure and temperature in order to transfer the wavelike movement on the primery membrane to chosen parts of the secondary membrane and to chosen extents in order to control the treatment of the body part in a predetermined way in order to stimulate or reduce the development of different functions and conditions.

11. Use of a device for exercising massage to parts of the body and/or skin according to claim 1 for massage of a body part.

12. Use of a device for exercising massage to parts of the body and/or skin according to claim 2 for massage of a body part.

13. Use of a device for exercising massage to parts of the body and/or skin according to claim 3 for massage of a body part.

14. Use of a device for exercising massage to parts of the body and/or skin according to claim 4 for massage of a body part.

15. Use of a device for exercising massage to parts of the body and/or skin according to claim 1 for applications dependant of plastic surgery

16. Use of a device for exercising massage to parts of the body and/or skin according to claim 2 for applications dependant of plastic surgery.

17. Use of a device for exercising massage to parts of the body and/or skin according to claim 7 for applications dependant of plastic surgery.

18. Use of a device for exercising massage to parts of the body and/or skin according to claim 1 for reducing weight, reducing fatness and/or slimming

19. Use of a device for exercising massage to parts of the body and/or skin according to claim 2 for reducing weight, reducing fatness and/or slimming

20. Use of a device for exercising massage to parts of the body and/or skin according to claim 3 for reducing weight, reducing fatness and/or slimming.
